(19) United States
(12) Patent Application Publication
(10) Pub. No.: US 2016/0006553 A1
(43) Pub. Date: Jan. 7, 2016

(54) METHOD AND APPARATUS FOR REPORTING DOWNLINK CHANNEL STATE

(71) Applicant: LG ELECTRONICS INC., Seoul (KR)

(72) Inventors: Kijun KIM, Seoul (KR); Jonghyun PARK, Seoul (KR); Hyukjin CHAE, Seoul (KR)

(73) Assignee: LG ELECTRONICS INC., Seoul (KR)

(21) Appl. No.: 14/767,876

(22) PCT Filed: Feb. 21, 2014
(86) PCT No.: PCT/KR2014/001425

§ 371 Date: Aug. 13, 2015

Related U.S. Application Data
(60) Provisional application No. 61/768,526, filed on Feb. 24, 2013.

(51) Int. Cl. H04L 5/00; H04W 24/08; H04B 7/04

(52) U.S. Cl. CPC H04L 5/0057; H04L 5/0023; H04L 5/005; H04B 7/0486; H04B 7/0417; H04W 24/08

(57) ABSTRACT

A method and apparatus for reporting a downlink channel state to a serving Base Station (BS) at a User Equipment (UE) in a wireless communication system in which each of N (N is an integer equal to or larger than 2) BSs transmits one or more independent layers to the UE are disclosed. The method includes receiving configuration information about a channel state information reference signal (CSI-RS) process including CSI-RS resource i (i=0, . . . , N—1) and one channel state information interference measurement (CSI-IM) resource, the CSI-RS resource i being allocated to BS i from among the N BSs, performing channel measurement in CSI-RS resource i to measure downlink channel Hᵢ from BS i, and transmitting, to the serving BS, a channel state report including a precoding matrix index i (PMIᵢ) and a rank indicator i (RIᵢ), which maximize throughput of downlink channels from the N BSs, and/or a channel quality indicator i (CQIi). The RIᵢ may range from 0 to Lₘₐₓ and Lₘₐₓ is a maximum number of layers which the UE is able to receive.

### TECHNICAL FIELD

The present invention relates to a wireless communication system, and more particularly, to a method and apparatus for reporting a downlink channel state, when a plurality of Base Stations (BSs) or transmission points transmit downlink signals to one User Equipment (UE).

### BACKGROUND ART

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier-aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### DISCLOSURE

### Technical Problem

An object of the present invention is to provide a method for efficiently reporting a downlink channel state.

It will be appreciated by persons skilled in the art that the effects that can be achieved through the present invention are not limited to what has been particularly described hereinabove and other advantages of the present invention will be more clearly understood from the following detailed description.

### Technical Solution

The object of the present invention can be achieved by providing a method for reporting a downlink channel state to a serving. Base Station (BS) at a User Equipment (UE) in a wireless communication system in which each of N (N is an integer equal to or larger than 2) BSs transmits one or more independent layers to the UE, including receiving configuration information about a channel state information reference signal (CSI-RS) process including. CSI-RS resource i (i=0, . . . , N−1) and one channel state information interference measurement (CSI-IM) resource, the CSI-RS resource i being allocated to a BS i from among the N BSs; performing channel measurement in the CSI-RS resource i to measure downlink channel Hᵢ from the BS i; and transmitting, to the serving BS, a channel state report including a precoding matrix index i (PMIᵢ) and a rank indicator i (RIᵢ), which maximize throughput of downlink channels from the N BSs, and/or a channel quality indicator i (CQIᵢ), the RIᵢ may range from 0 to Lₘₐₓ and Lₘₐₓ is a maximum number of layers which the UE is able to receive.

Additionally or alternatively, the sum of N RI(RIᵢ)s may be equal to or smaller than Lₘₐₓ.

Additionally or alternatively, if the RIᵢ is 0, the PMIᵢ and the CQIᵢ may be excluded from the channel state report.

Additionally or alternatively, if the sum RI_{c} of N RI(RIᵢ)s is larger than 1, a CQI for codeword 0, CQIᵢ_{_{—}}₀ and a CQI for codeword 1, CQIᵢ_{_{—}}₁ may be included in the channel state report. The RI_{c} layers may be indexed in an ascending order, starting from a layer transmitted from a low-index BS, the codeword 0 may be mapped to layers having low indexes, and the codeword 1 may be mapped to layers having high indexes.

Additionally or alternatively, if RI_{c} is an even number, the number of layers to which the codeword 0 is mapped may be the same as the number of layers to which the codeword 1 is mapped, and if RI_{c} is an odd number, the number of layers to which the codeword 1 is mapped may be larger than the number of layers to which the codeword 0 is mapped by 1.

Additionally or alternatively, if the sum RI_{c} of N RI(RIᵢ)s is larger than 1, a CQI for codeword 0, CQIᵢ_{_{—}}₀ and a CQI for codeword 1, CQIᵢ_{_{—}}₁ may be included in the channel state report. The RIᵢ layers of each BS may be indexed sequentially in an ascending order, the codeword 0 may be mapped to layers having low indexes transmitted from each BS, and the codeword 1 may be mapped to layers having high indexes transmitted from each BS.

Additionally or alternatively, if the RIᵢ is an even number, the number of layers to which the codeword 0 is mapped may be the same as the number of layers to which the codeword 1 is mapped. If RIᵢ is an odd number, a new index may be assigned to a BS having the odd number RIᵢ. If the new index is an even number, the number of layers to which the codeword 1 is mapped may be larger than the number of layers to which the codeword 0 is mapped by 1, and if the new index is an odd number, the number of layers which the codeword 0 is mapped may be larger than the number of layers to which the codeword 1 is mapped by 1.

Additionally or alternatively, the method may further include reflecting interference from one or more layers received from a BS for which the RIᵢ is not 0 in calculating the CQIᵢ.

Additionally or alternatively, the method may further include receiving information indicating that each of the N BSs transmits one or more independent layers to the UE.

In another aspect of the present invention, provided herein is a UE for reporting a downlink channel state to a serving BS in a wireless communication system in which each of N (N is an integer equal to or larger than 2) BSs transmits one or more independent layers to the UE, including a Radio Frequency (RF) unit, and a processor configured to control the RF unit. The processor is configured to receive configuration information about a channel state information reference signal (CSI-RS) process including CSI-RS resource i (i=0, . . . , N−1) and one channel state information interference measurement (CSI-IM) resource, the CSI-RS resource i being allocated to BS i from among the N BSs, perform channel measurement in the CSI-RS resource i to measure downlink channel Hᵢ from BS i, and transmit, to the serving BS, a channel state report including a precoding matrix index i (PMIᵢ) and a rank indicator i (RIᵢ), which maximize throughput of downlink channels from the N BSs, and/or a channel quality indicator i (CQIᵢ). The RIᵢ ranges from 0 to Lₘₐₓ and Lₘₐₓ is a maximum number of layers which the UE is able to receive.

The above description corresponds to part of embodiments of the present invention and various embodiments reflecting technical characteristics of the present invention are derived and understood by those skilled in the art on the basis of the following detailed description of the present invention.

### Advantageous Effects

As is apparent from the above description, exemplary embodiments of the present invention can efficiently report downlink channel state information, such that a higher-quality communication environment can be expected in a coordinated multiple point transmission and reception (CoMP) system.

It will be appreciated by persons skilled in the art that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a diagram showing an example of a radio frame structure used in a wireless communication system;

FIG. 2 is a diagram showing an example of a downlink/uplink (DL/UL) slot structure in a wireless communication system;

FIG. 3 is a diagram showing a downlink (DL) subframe structure used in a 3GPP LTE/LTE-A system;

FIG. 4 is a diagram showing an uplink (UL) subframe structure used in a 3GPP LTE/LTE-A system;

FIG. 5 is a diagram showing mapping channel state information-reference signal used in a 3GPP LTE/LTE-A system;

FIG. 6 is a diagram showing a wireless communication system applying a coordinated multiple point transmission and reception (CoMP).

FIG. 7 is a diagram showing a wireless communication system applying a specific-CoMP.

FIG. 8 is a diagram showing a procedure of an embodiment of the present invention; and

FIG. 9 is a block diagram of an apparatus for implementing embodiment(s) of the present invention.

### BEST MODE

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g. macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowlegement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

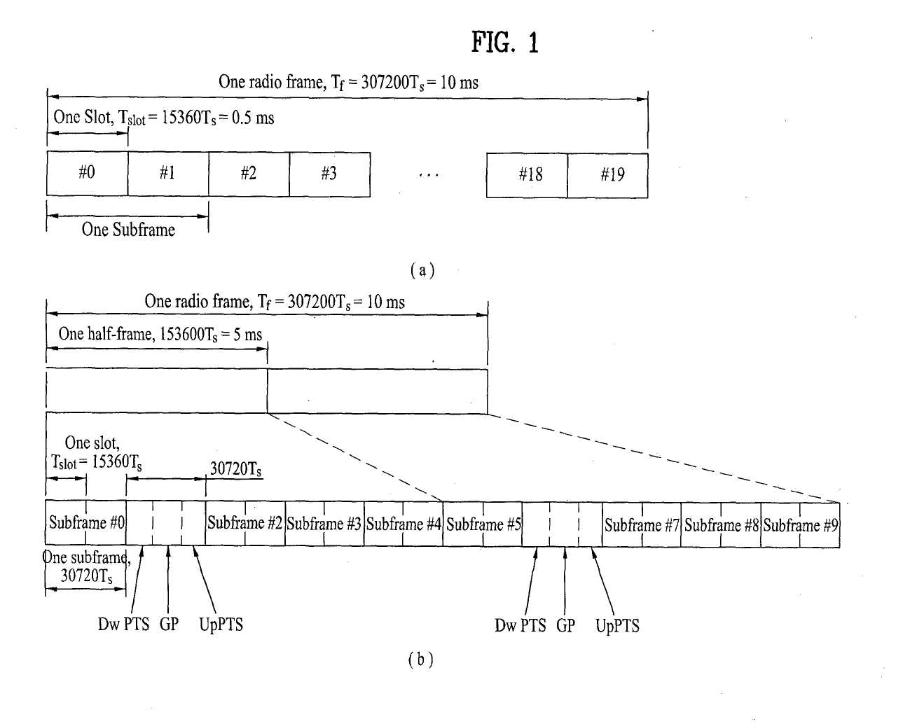

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| | to-Uplink | | | | | | | | | | |
| | Switch- | | | | | | | | | | |
| DL-UL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended | | Normal | Extended |
| subframe | | prefix in | cyclic prefix | | cyclic prefix | cyclic prefix |
| configuration | DwPTS | uplink | in uplink | DwPTS | in uplink | in uplink |
| 0 | 6592 · Tₛ | 2192 · Ts | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

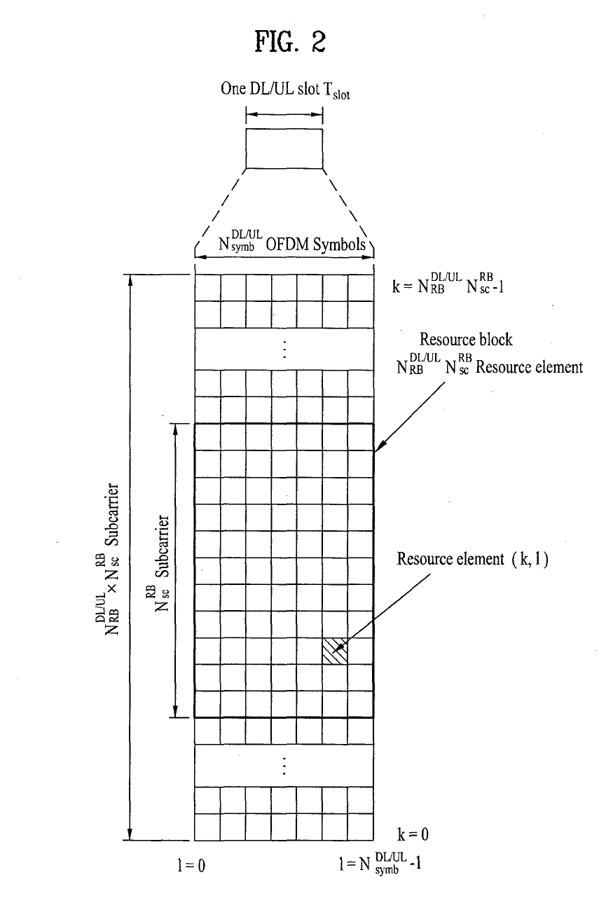

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g. 7) consecutive OFDM symbols in the time domain and N_{sc}^{RB} (e.g. 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index).

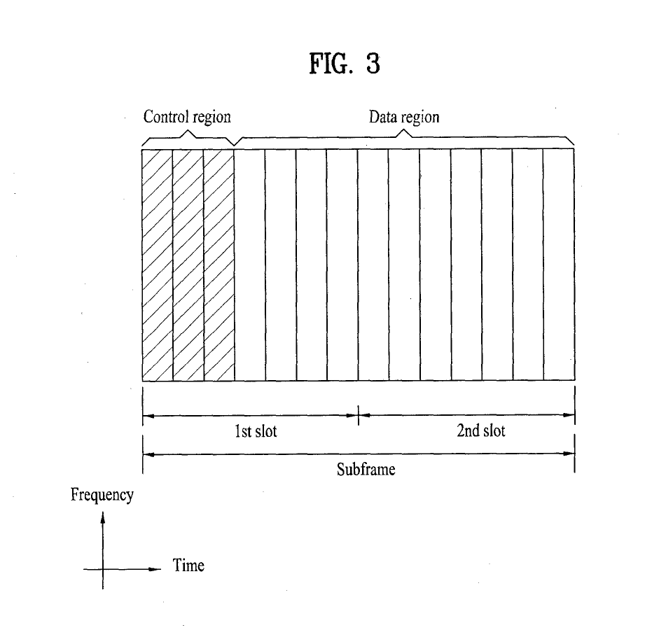

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g. frequency position) of “B” and transmission format information (e.g. transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

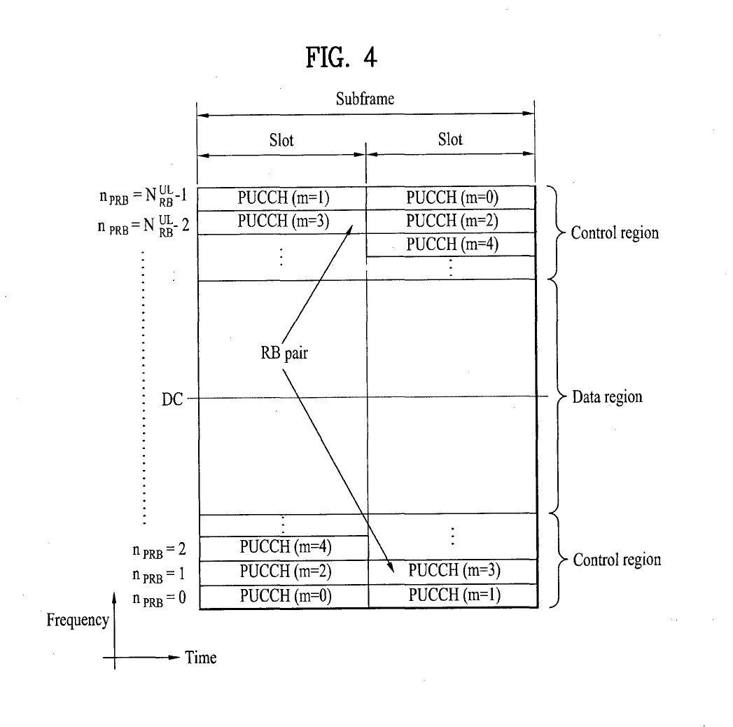

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (HACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 3 shows the mapping relationship between PUCCH formats and UCI in LTE/LTE-A.

TABLE 3

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK | |
| | | | or CQI/PMI/RI + | |
| | | | ACK/NACK | |

Referring to Table 3, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

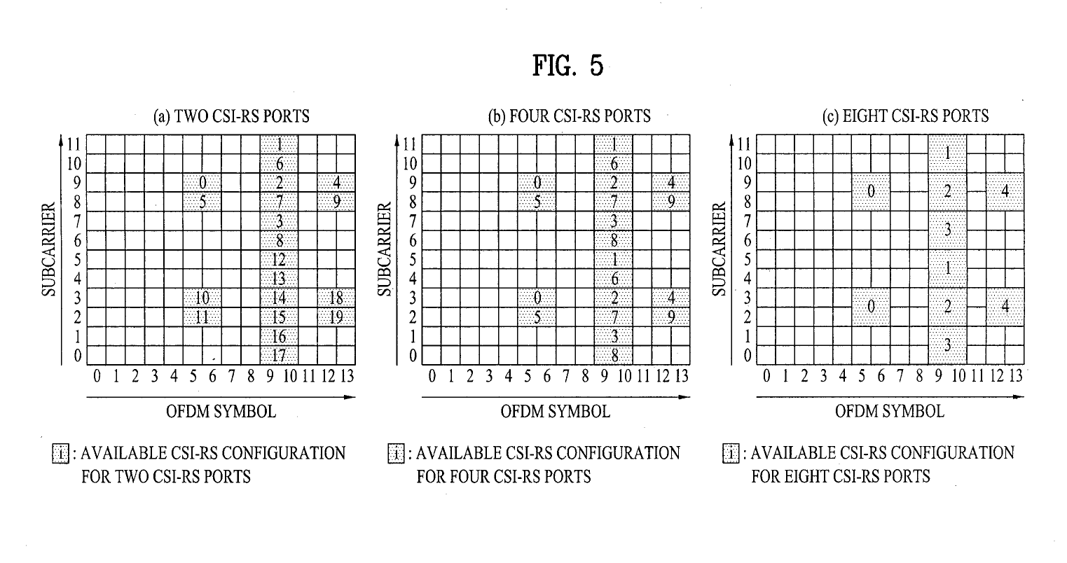

FIG. 5 shows a CSI-RS mapping pattern according to an antenna port. The antenna port configured to transmit CSI-RS is referred to as a CSI-RS port, and the position of a resource contained in a predetermined resource region in which CSI-RS port(s) transmit(s) the corresponding CSI-RS(s) is referred to as a CSI-RS pattern or a CSI-RS resource configuration. In addition, time-frequency resources through which CSI-RS is allocated/transmitted are referred to as CSI-RS resources. For example, a resource element (RE) used for CSI-RS transmission is referred to as CSI-RS RE. Unlike CRS in which the RE position at which CRS per antenna port is transmitted is fixed, CSI-RS has a maximum of 32 different constructions so as to reduce inter-cell interference (ICI) under a multi-cell environment including a heterogeneous network environment. Different CSI-RS constructions are made according to the number of antenna ports contained in the cell, and contiguous cells may be configured to have different structures. Unlike CRS, CSI-RS may support a maximum of 8 antenna ports (p=15, p=15, 16, p=15, . . . , 18, and p=15, . . . , 22), and CSI-RS may be defined only for f=15 kHz. The antenna ports (p=15, . . . , 22) may correspond to CSI-RS ports (p=0, . . . , 7), respectively.

FIG. 5 exemplarily shows CSI-RS structures. Specifically, FIG. 5 shows the position of resources occupied by CSI-RS in one RB pair according to individual CSI-RS structures.

FIG. 5(a) shows 20 CSI-RS structures available for CSI-RS transmission by two CSI-RS ports. FIG. 5(b) shows 10 CSI-RS structures available by 4 CSI-RS ports, and FIG. 5(c) shows 5 CSI-RS structures available by 8 CSI-RS ports. Numbers may be assigned to respective CSI-RS structures defined by the number of CSI-RS ports.

If a base station (BS) constructs two antenna ports for CSI-RS transmission, i.e., if two CSI-RS ports are constructed, the two CSI-RS ports are configured to perform CSI-RS transmission on radio resources corresponding to one of 20 CSI-RS structures shown in FIG. 5(a). If the number of CSI-RS ports constructed for a specific is 4, the four CSI-RS ports may transmit CSI-RS on CSI-RS resources configured for the specific cell from among 10 CSI-RS structures shown in FIG. 5(b). Likewise, assuming that the number of CSI-RS ports configured for the specific cell is set to 8, the 8 CSI-RS ports may transmit CSI-RS on CSI-RS resources configured for the specific cell from among 5 CSI-RS structures shown in FIG. 5(c).

The CSI-RS structures have nested property. The nested property may indicate that a CSI-RS structure for a large number of CSI-RS ports is used as a super set of a CSI-RS structure for a small number of CSI-RS ports. Referring to FIGS. 5(b) and 5(c), REs configured to construct CSI-RS structure #0 regarding 4 CSI-RS ports are contained in resources configured to construct CSI-RS structure #0 regarding 8 CSI-RS ports.

A plurality of CSI-RSs may be used in a given cell. In the case of non-zero power CSI-RS, only CSI-RS for one structure is transmitted. In the case of zero-power CSI-RS, CSI-RS of a plurality of structures can be transmitted. From among resources corresponding to the zero-power CSI-RS, the UE proposes zero transmit (Tx) power for resources other than resources to be proposed as non-zero power CSI-RS. For example, in the case of a radio frame for TDD, no CSI-RS is transmitted in any one of a special subframe in which DL transmission and UL transmission coexist, a subframe in which a paging message is transmitted, and a subframe in which transmission of a synchronous signal, physical broadcast channel (PBCH) or system information block type 1 (SIB1) collides with CSI-RS. The UE assumes that no CSI-RS is transmitted in the above subframes. Meanwhile, time-frequency resources used by the CSI-RS port for transmission of the corresponding CSI-RS are not used for PDSCH transmission, and are not used for CSI-RS transmission of other antenna ports instead of the corresponding CSI-RS port.

Time-frequency resources used for CSI-RS transmission are not used for data transmission, such that a data throughput is reduced in proportion to the increasing CSI-RS overhead. Considering this fact, CSI-RS is not constructed every subframe, and the CSI-RS is transmitted at intervals of a predetermined transmission period corresponding to a plurality of subframes. In this case, compared to the case in which CSI-RS is transmitted every subframe, the amount of CSI-RS transmission overhead can be greatly reduced. The above-mentioned subframe will hereinafter be referred to as a CSI-RS subframe configured for CSI-RS transmission.

A base station (BS) can inform a UE of the following parameters through higher layer signaling (e.g., MAC signaling, RRC signaling, etc.).
Number of CSI-RS ports
CSI-RS structure
CSI-RS subframe structure I_{CSI-RS}
CSI-RS subframe structure period T_{CSI-RS}
CSI-RS subframe offset Δ_{CSI-RS}

If necessary, the BS (or eNB) may inform the UE of not only a CSI-RS structure transmitted at zero power, but also a subframe used for transmission of the zero-power CSI-RS structure.

Channel State Information—Interference Measurement (CSI-IM)

For the 3GPP LTE Rel-11 UE, one or more CSI-IM resource structures may be configured. CSI-IM resource may be used to measure interference. The CSI-RS structure and the CSI-RS subframe structure (ICSI-RS) shown in FIG. 5 may be configured through higher layer signaling for each CSI-IM resource.

CSI Report

In a 3GPP LTE(-A) system, a user equipment (UE) reports channel state information (CSI) to a base station (BS) and CSI refers to information indicating quality of a radio channel (or a link) formed between the UE and an antenna port. For example, the CSI includes a rank indicator (RI), a precoding matrix indicator (PMI), a channel quality indicator (CQI), etc. Here, the RI indicates rank information of a channel and means the number of streams received by the UE via the same time-frequency resources. Since the value of the RI is determined depending on long term fading of the channel, the RI is fed from the UE back to the BS with periodicity longer than that of the PMI or the CQI. The PMI has a channel space property and indicates a precoding index preferred by the UE based on a metric such a signal to interference plus noise ratio (SINR). The CQI indicates the strength of the channel and means a reception SINR obtained when the BS uses the PMI.

Based on measurement of the radio channel, the UE may calculate a preferred PMI and RI, which may derive an optimal or best transfer rate when used by the BS, in a current channel state and feed the calculated PMI and RI back to the BS. The CQI refers to a modulation and coding scheme for providing acceptable packet error probability for the fed-back PMI/RI.

Meanwhile, in an LTE-A system which includes more accurate MU-MIMO and explicit CoMP operations, current CSI feedback is defined in LTE and thus may not sufficiently support operations to be newly introduced. As requirements for CSI feedback accuracy become more complex in order to obtain sufficient MU-MIMO or CoMP throughput gain, the PMI is composed of two PMIs such as a long term/wideband PMI (W₁) and a short term/subband PMI (W₂). In other words, a final PMI is expressed by a function of W₁ and W₂. For example, the final PMI W may be defined as follows: W=Wᵢ*W₂ or W=W₂*Wᵢ. Accordingly, in LTE-A, a CSI may be composed of RI, W₁, W₂ and CQI.

In the 3GPP LTE(-A) system, an uplink channel used for CSI transmission is shown in Table 4 below.

TABLE 4

| | Periodic CSI | Aperiodic CSI |
|---|---|---|
| Scheduling scheme | transmission | transmission |
| Frequency non-selective | PUCCH | — |
| Frequency selective | PUCCH | PUSCH |

Referring to Table 6, the CSI may be transmitted using a physical uplink control channel (PUCCH) with periodicity determined by a higher layer or may be aperiodically transmitted using a physical uplink shared channel (PUSCH) according to the demand of a scheduler. If the CSI is transmitted using the PUSCH, only frequency selective scheduling method and an aperiodic CSI transmission method are possible. Hereinafter, the scheduling scheme and a CSI transmission scheme according to periodicity will be described.

1) CQI/PMI/RI transmission via PUSCH after receiving CSI transmission request control signal.

A control signal for requesting transmission of a CSI may be included in a PUSCH scheduling control signal (UL grant) transmitted via a PDCCH signal. Table 5 below shows the mode of the UE when the CQI, the PMI and the RI are transmitted via the PUSCH.

TABLE 5

| | | PMI feedback type | | |
|---|---|---|---|---|
| | | No PMI | Single PMI | Multiple PMIs |
| PUSCH | Wideband | | | Mode 1-2 |
| CQI | (wideband CQI) | | | |
| feedback | UE selection | Mode 2-0 | | Mode 2-2 |
| type | (subband CQI) | | | |
| | Higher layer | Mode 3-0 | Mode 3-1 | |
| | configuration | | | |
| | (subband CQI) | | | |

The transmission mode of Table 5 is selected at a higher layer and the CQI/PMI/RI is transmitted in the same PUSCH subframe. Hereinafter, an uplink transmission method of the UE according to mode will be described.

Mode 1-2 indicates the case in which a precoding matrix is selected on the assumption that data is transmitted via only a subband with respect to each subband. The UE generates a CQI on the assumption that a precoding matrix is selected with respect to an entire set S specified by a higher layer or a system bandwidth. In Mode 1-2, the UE may transmit the CQI and the PMI value of each subband. At this time, the size of each subband may be changed according to system bandwidth.

In mode 2-0, the UE may select M preferred subbands with respect to the set S specified at the higher layer or the system bandwidth. The UE may generate one CQI value on the assumption that data is transmitted with respect to the selected M subbands. The UE preferably reports one CQI (wideband CQI) value with respect to the set S or the system bandwidth. The UE defines the CQI value of each codeword in the form of a difference if a plurality of codewords is present with respect to the selected M subbands.

At this time, the differential CQI value is determined by a difference between an index corresponding to the CQI value of the selected M subbands and a wideband CQI (WB-CQI) index.

In Mode 2-0, the UE may transmit a CQI value generated with respect to a specified set S or an entire set and one CQI value for the selected M subbands to the BS. At this time, the size of the subband and the M value may be changed according to system bandwidth.

In Mode 2-2, the UE may simultaneously select the locations of M preferred subbands and a single precoding matrix for the M preferred subbands on the assumption that data is transmitted via the M preferred subbands. At this time, the CQI value for the M preferred subbands is defined per codeword. In addition, the UE further generates a wideband CQI value with respect to the specified set S or the system bandwidth.

In Mode 2-2, the UE may transmit information about the locations of the M preferred subbands, one CQI value for the selected M subbands, a single PMI for the M preferred subbands, a wideband PMI and a wideband CQI value to the BS. At this time, the size of the subband and the M value may be changed according to system bandwidth.

In Mode 3-0, the UE generates a wideband CQI value. The UE generates the CQI value for each subband on the assumption that data is transmitted via each subband. At this time, even in case of RI>1, the CQI value indicates only the CQI value for a first codeword.

In Mode 3-1, the UE generates a single precoding matrix with respect to the specified set S or the system bandwidth. The UE generates a subband CQI on a per codeword basis on the assumption of the single precoding matrix generated with respect to each subband. In addition, the UE may generate a wideband CQI on the assumption of a single precoding matrix. The CQI value of each subband may be expressed in the form of a difference. The subband CQI value is calculated by a difference between a subband CQI index and a wideband CQI index. At this time, the size of the subband may be changed according to system bandwidth.

2) Periodic CQI/PMI/RI Transmission Via PUCCH

The UE may periodically transmit the CSI (e.g., CQI/PMI/RI information) to the BS via the PUCCH. If the UE receives a control signal for requesting transmission of user data, the UE may transmit the CQI via the PUCCH. Even when the control signal is transmitted via the PUSCH, the CQI/PMI/RI may be transmitted using one of the modes defined in Table 6 below.

TABLE 6

PMI feedback type

| | | No PMI | Single PMI |
|---|---|---|---|
| PUCCH | Wideband | Mode 1-0 | Mode 1-1 |
| CQI | (wideband CQI) | | |
| feedback | UE selection | Mode 2-0 | Mode 2-1 |
| type | (subband CQI) | | |

The UE may have the transmission modes shown in Table 6. Referring to Table 6, in Mode 2-0 and Mode 2-1, a bandwidth (BP) part is a set of subbands continuously located in a frequency domain and may cover a system bandwidth or a specified set S. In Table 6, the size of each subband, the size of the BP and the number of BPs may be changed according to system bandwidth. In addition, the UE transmits the CQI in a frequency domain in ascending order per BP so as to cover the system bandwidth or the specified set S.

According to a transmission combination of the CQI/PMI/RI, the UE may have the following four transmission types.

i) Type 1: A subband CQI (SB-CQI) of Mode 2-0 and Mode 2-1 is transmitted.

ii) Type 2: A wideband CQI and a PMI (WB-CQI/PMI) are transmitted.

iii) Type 3: An RI is transmitted.

iv) Type 4: A wideband CQI is transmitted.

If the UE transmits the RI and the wideband CQI/PMI, the CQI/PMI is transmitted in subframes having different offsets and periodicities. In addition, if the RI and the wideband CQI/PMI should be transmitted in the same subframe, the CQI/PMI is not transmitted.

In Table 6, the transmission periodicity of the wideband CQI/PMI and the subband CQI is P and has the following properties.
The wideband CQI/PMI has periodicity of H*P. At this time, H=J*K+1, wherein J denotes the number of BPs and K denotes the number of periodicities of the BP. That is, the UE performs transmission at {0, H, 2H, . . . }.
The CQI is transmitted at a time of J*K rather than when the wideband CQI/PMI is transmitted.

In Table 6, the transmission periodicity of the RI is a multiple m of that of the wideband CQI/PMI and has the following properties.
The offsets of the RI and the wideband CQI/PMI are 0 and, if the RI and the wideband CQI/PMI are transmitted in the same subframe, the wideband CQI/PMI is not transmitted.

Parameters P, H, K and O described in Table 6 are all determined at the higher layer of the UE and signaled to a physical layer of the UE.

Hereinafter, a feedback operation according to the mode of the UE will be described with reference to Table 6. If the UE is in Mode 1-0 and the RI is transmitted to the BS, the UE generates the RI with respect to the system bandwidth or the specified set S and transmits Type 3 report for transmitting the RI to the BS. If the UE transmits the CQI, the wideband CQI is transmitted.

If the UE is in Mode 1-1 and transmits the RI, the UE generates the RI with respect to the system bandwidth or the specified set S and transmits a Type 3 report for transmitting the RI to the BS. If the UE transmits the CQI/PMI, a single precoding matrix is selected in consideration of the recently transmitted RI. That is, the UE transmits a type 2 report composed of a wideband CQI, a single precoding matrix and a differential wideband CQI to the BS.

If the UE is in Mode 2-0 and transmits the RI, the UE generates the RI with respect to the system bandwidth or the specified set S and transmits a Type 3 report for transmitting the RI to the BS. If the UE transmits the wideband CQI, the UE generates the wideband CQI and transmits a Type 4 report to the BS on the assumption of the recently transmitted RI. If the UE transmits the CQI for the selected subband, the UE selects a most preferred subband with respect to J BPs composed of N subbands and transmits a Type 1 report to the BS. The type 1 report may be transmitted via one or more subframes according to the BP.

If the UE is in Mode 2-1 and transmits the RI, the UE generates the RI with respect to the system bandwidth or the specified set S and transmits a Type 3 report for transmitting the RI to the BS. If the UE transmits the wideband CQI to the BS, the UE generates the wideband CQI and transmits a Type 4 report to the BS in consideration of the recently transmitted RI. If the CQI for the selected subbands is transmitted, the UE generates a difference between a single CQI value for the selected subbands in the BP in consideration of the recently transmitted PMI/RI and a CQI of a codeword on the assumption that a single precoding matrix is used for the selected subbands and the recently transmitted RI if the RI is greater than 1 with respect to J BPs composed of Nj subbands and transmits a Type 1 report to the BS.

In addition to estimation (CSI reporting) of the channel state between the BS and the UE, for reduction of an interference signal and demodulation of a signal transmitted between the BS and the UE, various reference signals (RSs) are transmitted between the BS and the UE. The reference signal means a predefined signal having a special waveform, which is transmitted from the BS to the UE or from the UE to the BS and is known to the BS and the UE, and is also referred to as pilot. In 3GPP LTE release 8 (hereinafter, Rel-8), a cell specific reference signal (CRS) is proposed for the purpose of channel measurement of CQI feedback and demodulation of a physical downlink shared channel (PDSCH). However, after 3GPP LTE release 10 (hereinafter, Rel-10), separately from the CRS of Rel-8, a channel state information-reference signal (CSI-RS) for CSI feedback is proposed according to Rel-10.

Each BS may transmit a CSI-RS for channel measurement to the UE via a plurality of antenna ports and each UE may calculate channel state information based on the CSI-RS and transmit the channel state information to each BS in response thereto.

The present invention provides a CSI feedback scheme, in consideration of CoMP JT in which each cooperative transmission point transmits an independent data layer. According to the CSI feedback scheme, an RI and a PMI for use in each transmission point are individually fed back and a CQI is reported for each codeword, reflecting interference of an independent data layer transmitted from each transmission point.

JT Scheme

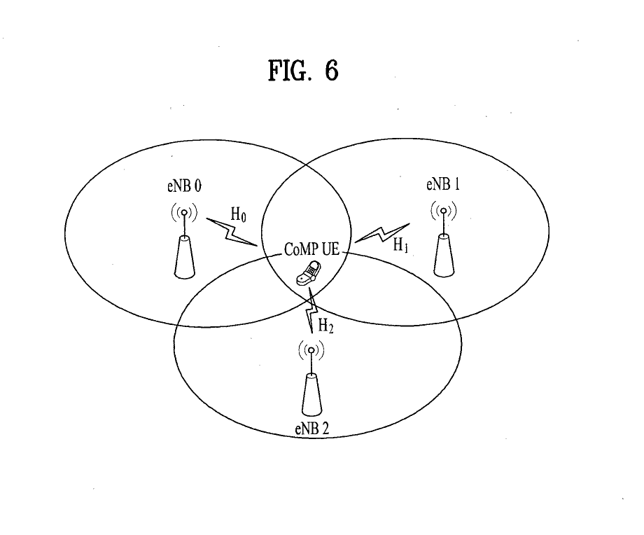

FIG. 6 illustrates a configuration of a wireless communication system to which CoMP JT is applied. In CoMP JT, a plurality of transmission points simultaneously transmit data to one UE through cooperation. In the illustrated case of FIG. 6, three transmission points cooperatively transmit signals in the JT scheme. While the transmission points are shown as located at different geographical positions in FIG. 6 by way of example, the present invention is also applicable to a case where the transmission points are located at the same position and transmit signals in different transmission directions. A UE regards a transmission point as a point that transmits a configured CSI-RS. Therefore, if a plurality of CSI-RSs are configured for the UE, the transmission points that transmit the CSI-RSs may be located at the same or different positions.

If N transmission points cooperate in transmitting signals to a UE, a signal received at the UE is expressed as [Equation 1].

$$\begin{matrix}y = {H}_{c} {P}_{c} x + n \\ = [ {H}_{0} {H}_{1} ⋯ {H}_{N - 1} ] {P}_{c} x + n\end{matrix} \qquad [ Equation 1 ]$$

where Hᵢ is a MIMO channel matrix between an ith transmission point and the UE. The number of rows of the matrix Hᵢ is the number of reception antennas of the UE, and the number of columns of the matrix Hᵢ is the number aᵢ of transmission antennas of the ith transmission point. x and y represent a transmission data vector and a received signal vector, respectively. n represents a noise and interference signal vector. P_{c} is a composite precoder matrix. The number of rows in the matrix P_{c} is the sum of the numbers of transmission antennas of all cooperative transmission points, given as Σaᵢ and the number of columns in the matrix P_{c} is equal to the number L of transmission data layers.

In JT, a precoded transmission signal P_{c}x is transmitted on a composite channel H_{c}. The UE reports a composite precoder matrix P_{c} that that maximizes the throughput of composite MIMO channels described in [Equation 1] and a CQI achieved by using the composite precoder matrix P_{c} as a CSI feedback to an eNB according to the JT scheme.

The composite precoder matrix P_{c} reported by the CSI feedback is limited to the matrices of a codebook of a finite size, taking into account feedback overhead. In the LTE(-A) system, each transmission point has 1, 2, 4, or 8 antennas and codebooks are predefined for 2, 4, and 8 ports, respectively. To feedback the whole composite precoder matrix P_{c} at one time, a new codebook for Σaᵢ ports should be defined. However, even for cooperative transmission of up to three transmission points, a large number of values are available as Σaᵢ. The resulting increase in the number of required codebooks increases complexity.

To avoid this problem, the composite precoder matrix P_{c} is divided into precoder matrices Pᵢ each applied to the transmission antennas of an i^{th} transmission point as described in [Equation 2] and each precoder matrix Pᵢ (i=0, . . . , N−1) maximizing a throughput and a CQI corresponding to the precoder matrix Pᵢ are reported as a CSI feedback to the eNB.

$$\begin{matrix}y = {H}_{c} {P}_{c} x + n \\ = [ {H}_{0} {H}_{1} ⋯ {H}_{N - 1} ] [ \begin{matrix}{P}_{0} \\ {P}_{1} \\ ⋮ \\ {P}_{N - 1}\end{matrix} ] x + n \\ = {\sum }_{i = 0}^{N - 1} {H}_{i} {P}_{i} x + n\end{matrix} \qquad [ Equation 2 ]$$

Because Pᵢ is a precoder matrix applied to the transmission antennas of an i^{th} transmission point, it may be fed back using an existing codebook for 2, 4, or 8 ports. However, an existing aᵢ-port codebook supports only up to aᵢ data layers. Therefore, a feedback rank available in feeding back each precoder matrix Pᵢ using the aᵢ-port codebook is limited to min(aᵢ). For example, if transmission point A with 2 antennas and transmission point B with 4 antennas transmit signals to a UE with 8 reception antennas in JT, up to 6 data layers may be transmitted theoretically. However, since the UE feeds back a precoder for transmission point A from a 2-port codebook and a precoder for transmission point B from a 4-port codebook, the feedback rank for JT is limited to min(2,4) Thus it may be concluded that to maximize a Spatial Multiplexing (SM) gain achievable from Σaᵢ aggregated antenna ports, the existing codebooks need modification. For example, a precoder matrix that enables transmission of aᵢ or more data layers should be added to the aᵢ-port codebook.

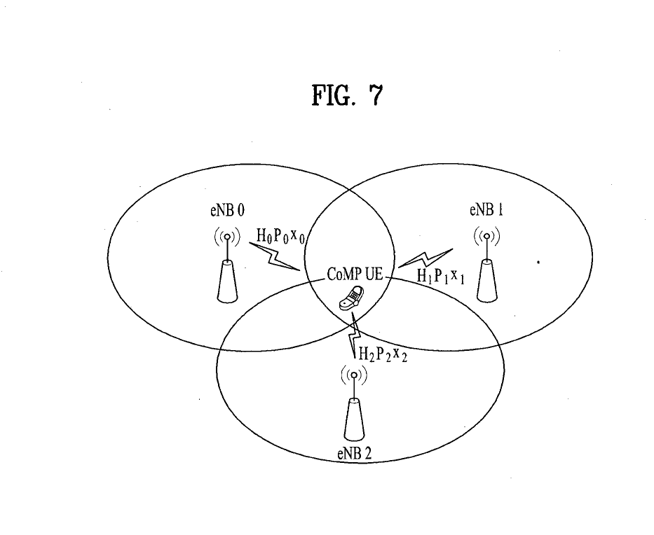

To maximize an SM gain using the existing codebooks, the following JT scheme is considered.

$$\begin{matrix}y = {H}_{c} {P}_{c} x + n \\ = [ {H}_{0} {H}_{1} ⋯ {H}_{N - 1} ] [ \begin{matrix}{P}_{0} & 0 & ⋯ & 0 \\ 0 & {P}_{1} & ⋯ & 0 \\ ⋮ & ⋮ & ⋱ & ⋮ \\ 0 & 0 & ⋯ & {P}_{N - 1}\end{matrix} ] [ \begin{matrix}{x}_{0} \\ {x}_{1} \\ ⋮ \\ {x}_{N - 1}\end{matrix} ] + n \\ = {\sum }_{i = 0}^{N - 1} {H}_{i} {P}_{i} {x}_{i} + n\end{matrix} \qquad [ Equation 3 ]$$

where xᵢ represents a data vector transmitted from the ith transmission point. That is, each transmission point transmits independent data layers. Thus the JT scheme described as [Equation 3] will be referred to as Independent Layer Joint Transmission (ILJT). FIG. 7 illustrates an example in which three transmission points transmit signals through cooperation by ILJT. Pᵢ represents a precoder matrix applied to an ith transmission data vector in the ith transmission point. The number of columns in the precoder matrix Pᵢ is equal to the number of rows of the data vector xᵢ, representing the number Lᵢ of transmission data layers transmitted by the ith transmission point. For a receiver to successfully detect data, the number Lᵢ of transmission data layers should be equal to or smaller than the number aᵢ of transmission antennas at the ith transmission point. Therefore, even though each precoder matrix Pᵢ (i=0, . . . , N−1) is fed back using an existing codebook during a CSI feedback operation, up to a maximum rank available to each transmission point may be fed back. In ILJT, the sum of the numbers Lᵢ of transmission data layers at all transmission points, L_{c}=ΣLᵢ is the number of composite data layers.

Compared to the scheme described in [Equation 1] and [Equation 2], the ILJT scheme limits the composite precoder matrix except for a diagonal sub-matrix to a zero matrix. Despite the resulting loss of precoding flexibility, the ILJT scheme enables feedback of all possible ranks based on existing codebooks, thereby reducing feedback complexity and overhead.

Dynamic Point Selection (DPS), Dynamic Point Blanking (DPB), and Coordinated Scheduling and Coordinated Beamforming (CSCB)

In a transmission scheme in which only one transmission point transmits data to a UE, such as DPS, DPB, or CSCB, a precoder matrix Pᵢ maximizing the throughput of MIMO channels and a CQI achieved by the precoder matrix Pᵢ are reported as a CSI feedback for an i^{th} transmission point to an eNB.

yᵢ=HᵢPᵢxᵢ+nᵢ (i=0, . . . ,N−1) [Equation 4]

where Hᵢ represents a MIMO channel matrix between the i^{th} transmission point and the UE, measured from an i^{th} CSI-RS configured for the UE. The UE also measures a statistic characteristic of nᵢ, mainly an auto-covariance matrix from a i^{th} Channel State Information Interference Measurement (CSI-IM) resource configured for the UE. To receive feedbacks of downlink channel states between the UE and a plurality of transmission points, the eNB allocates a plurality of CSI processes to the UE. A CSI-RS resource for MIMO channel measurement and a CSI-IM resource for interference environment measurement are allocated to each CSI process. Meanwhile, even though it has been described that the i^{th} transmission point transmits in the i^{th} CSI-RS (that is, the i^{th} transmission point uses the i^{th} CSI-RS), it is not excluding that a transmission point (or eNB) may use a plurality of CSI-RS.

In the case of cooperative transmission involving two transmission points, the eNB allocates CSI process 0 for downlink CSI reporting for transmission point 0 and CSI process 1 for downlink CSI reporting for transmission point 1. In this case, when the UE receives data from transmission point 0, interference from transmission point 1 is reflected in the measurement of interference from a signal received in a CSI-IM resource CSI-IM 0 from transmission point 1. Therefore, the transmission power and direction of the signal transmitted in the CSI-IM resource CSI-IM 0 by transmission point 1 affects the statistic characteristics of the interference measured by the UE.

Interference Between Layers

In acquiring each precoder matrix Pᵢ and a CQI corresponding to the precoder matrix Pᵢ in the ILJT scheme, a UE calculates the reception quality, mainly the reception SNIR of each transmission data layer. Herein, interference between multiple data layers should be reflected in the reception SINRs. That is, if two transmission points participate in cooperative transmission, transmission data layers from transmission point 1 should be considered as interference in calculating the reception SINR of a transmission data layer from transmission point 0. While interference from a signal transmitted by another transmission point may be reflected by controlling a signal in a CSI-IM resource in a conventional CSI feedback scheme using [Equation 4], the direction and amount of the interference may not be reflected accurately. In the ILJT scheme, a transmission signal from transmission point 1 interferes with transmission data layers from transmission point 0. The directionality of the interference is determined by a precoder matrix P₁ to be fed back. Therefore, in the conventional CSI feedback scheme using [Equation 4], a signal to which the precoder matrix P₁ is applied may not be transmitted in the CSI-IM resource CSI-IM₀ by predicting the precoder matrix P₁ that will be fed back, in advance.

The eNB may determine transmission layers and an MCS using a feedback based on a conventional CSI process as done using [Equation 4] in the ILJT scheme, only with a great estimation error for the above-described reason. Accordingly, a new CSI feedback for ILJT described in [Equation 3] should be defined to maximize the performance of ILJT.

ILJT CSI Process

A plurality of CSI-RSs and a single CSI-IM are assigned to a CSI process for ILJT. That is, if N transmission points transmit signals through cooperation, a CSI-RS transmitted by an i^{th} transmission point, CSI-RSᵢ (i=0, . . . , N−1) and one CSI-IM for measuring interference from points other than the N cooperative transmission points are assigned to the CSI process for ILJT. On the assumption of JUT signal transmission described in [Equation 3], Hᵢ is measured in CSI-RS; and a statistic characteristic of n is measured in the CSI-IM, and each precoder matrix Pᵢ maximizing throughput and a CQI corresponding to the precoder matrix Pᵢ are reported to an eNB. Meanwhile, even though it has been described that the i^{th} transmission point transmits in the i^{th} CSI-RS (that is, the i^{th} transmission point uses the i^{th} CSI-RS), it is not excluding that a transmission point (or eNB) may use a plurality of CSI-RS. In other words, a UE (terminal) may be configured with CSI-RSs as well the CSI-RS; (i=0, . . . , N−1), thereby a specific transmission point may use one or more CSI-RS. This may be applicable to all embodiments of the disclosure.

Zero Rank Indicator

The number of columns in a feedback precoder matrix Pᵢ is the number of layers expected from an i^{th} transmission points, that is, the rank of the precoder matrix Pᵢ. The precoder matrix Pᵢ is selected from the matrices of a codebook and is indicated by a PMI and an RI. Therefore, N RIs and PMIs are fed back in an ILJT CSI process. A feedback RI for a CSI process is generally between 1 and Lₘₐₓ. However, if an RI fed back in the ILJT scheme is 1 or above as is conventional, the UE should consider only a case where each transmission point transmits at least one data layer. In ILJT with N=2, if transmission point 0 transmits 2 layers and transmission point 1 transmits 0 layer, causing no interference, the throughput may be maximized. Therefore, it is proposed that a feedback RI has a value between 0 and Lₘₐₓ. If the feedback RI is 0, this means that the UE requests a corresponding transmission point to transmit no data.

According to the present invention, N RIs and PMIs are fed back in an ILJT CSI process. A feedback RI, RIi corresponding to an i^{th} CSI-RS, CSI-RSᵢ may range from 0 to L_{max,i}, if RIᵢ=0, a feedback PMI corresponding to the i^{th} CSI-RS, CSI-RSᵢ and/or a CQI corresponding to the PMI is not transmitted or is transmitted as NULL.

Sum Rank Restriction

According to the present invention, N RIs and PMIs are fed back in the ILJT CSI process. The sum of RIs RI_{c}=ΣRIᵢ is equal to or larger than 1. If the UE can receive only up to Lₘₐₓ data layers according to the number of antennas at the UE or the capability of an RF end of the UE, the sum of RI feedbacks should satisfy RI_{c}=ΣRIᵢ≦Lₘₐₓ (for example, if the UE has two receivers, RI₁=2 and RI₂=0 is possible, but RI₁=2 and RI₂=2 is impossible).

Codeword to Layer Mapping (2 Feedback CQIs)

A data unit to which an MCS and an HARQ process are independently applied is called a codeword. While an independent codeword may be transmitted individually in each transmission layer in MIMO, as the number of transmission layers increases, the number of transmitted codewords also increases. As a result, the amount of control information is increased. To mitigate this problem, the LTE(-A) system transmits one codeword for 1-layer transmission and two codewords for n-layer transmission (n>1). In the case of 2-codeword transmission in n layers (n>2), one codeword is mapped to a plurality of layers. Codeword to layer mapping represents what layer to which each codeword is mapped.

In the LTE(-A) system, codeword 0 is mapped to layers having lower indexes and codeword 1 is mapped to layers having higher indexes. If an even number of transmission layers are given, codeword 0 and codeword 1 are mapped to the same number of layers. If an odd number of transmission layers are given, codeword 1 is mapped to more layers than codeword 0 by one layer.

A CQI is calculated and fed back on a codeword basis in a CSI process. That is, for a feedback rank of 1, only a CQI for codeword 0 is fed back. For a feedback rank larger than 1, a CQI for codeword 0 and a CQI for codeword 1 are fed back.

According to the present invention, N RIs and PMIs are fed back in an ILJT CSI process. If RI_{c} is 1, only a CQI for codeword 0, CQI₀ is fed back. If RI_{c} is larger than 1, a CQI for codeword 0, CQI₀ and a CQI for codeword 1, CQI₁ are fed back. To calculate the CQIs, CQI₀ and CQI₁, a codeword to layer mapping relationship should be defined.

For codeword to layer mapping in ILJT, the following two mapping schemes are proposed.

[Scheme 1]

In consideration of a feedback RI and PMI, RIᵢ and PMLᵢ, the index of a first layer transmitted by an i^{th} transmission point is next to the index of a layer used in an (i−1)^{th} transmission point. That is, if the sum of feedback RIs is RI_{c}=RIᵢ, the layers are uniquely indexed with 0 to RI_{c}−1 and a lower layer index is first assigned to a lower-index transmission point. After codeword 0 is mapped to lower-index layers, codeword 1 is mapped to higher-index layers. If RI_{c} is an even number, each of codeword 0 and codeword 1 is mapped to the same number of layers and if RI_{c} is an odd number, codeword 1 is mapped to more layers than codeword 0 by one layer.

In the case where two transmission points cooperate with each other, if feedback RIs RI₀ and RI₁ are 2, a UE calculates CQIs, CQI₀ and CQI₁, assuming that codeword 0 is transmitted in two layers of transmission point 0 and codeword 1 is transmitted in two layers of a second transmission point 1. The UE considers interference from layers of transmission points for which RIs are non-zeroes, when calculating the CQIs. In this case, a system or a serving eNB may indicate to the UE that the two transmission points transmit independent layers, that is, the two transmission points serve the UE in ILJT.

[Scheme 2]

To map layers transmitted to each transmission point almost equally to codeword 0 and codeword 1, if a feedback rank for an i^{th} transmission point is RIᵢ, layers transmitted by the i^{th} transmission point are indexed with 0 from RIᵢ. Codeword 0 is mapped to lower-index layers, whereas codeword 1 is mapped to higher-index layers. New indexes starting from 0 are assigned only to transmission points for which RIᵢ is an odd number. If RIᵢ is an odd number and a new index is an even number, the number of layers mapped to codeword 1 is larger than the number of layers mapped to codeword 0 by 1. If RIᵢ is an odd number and the new index is an odd number, the number of layers mapped to codeword 0 is larger than the number of layers mapped to codeword 1 by 1.

In the case where two transmission points cooperate with each other, if feedback RIs RI₀ and RI₁ are 2, a UE calculates CQIs, CQI₀ and CQI₁, assuming that codeword 0 is transmitted in a first layer of each transmission point and codeword 1 is transmitted in a second layer of the transmission point.

In another proposal of the present invention, N RIs and PMIs, and a CQI are fed back from each transmission point in an ILJT CSI process to which N CSI-RSs and one CSI-IM are assigned. A CQI for an i^{th} transmission point, CQI(i) is a CQI for layers transmitted by the i^{th} transmission point. If an RI for the i^{th} transmission point, RI(i) is 0, PMI(i) and CQI(i) are not fed back or fed back as NULL. If RI(i) is 1, CQI(i) is a CQI for a data layer transmitted by the i^{th} transmission point. If RI(i) is larger than 1, CQI(i) includes two CQIs, that is, a CQI for codeword 0, CQI₀(i) and a CQI for codeword 1, CQI₁(i). The UE considers interference from layers of transmission points for which RIs are non-zeroes, when calculating the CQIs. In this case, a system or a serving eNB may indicate to the UE that the two transmission points transmit independent layers, that is, the two transmission points serve the UE in ILJT.

In another proposal of the present invention, N CSI processes each being assigned one CSI-RS and one CSI-IM are allocated to a UE and the UE feeds back an RI, a PMI, and a CQI for each CSI process. Then an eNB indicates to the UE that transmission points of a selected CSI process set participate in ILJT transmission and the UE considers a transmission signal from a transmission point in another CSI process of the same CSI process set to act as interference in calculating CQIs of the CSI process. The CSI process set participating in the ILJT transmission is preset by RRC signaling or indicated by Downlink Control Information (DCI) requesting aperiodic CSI reporting.

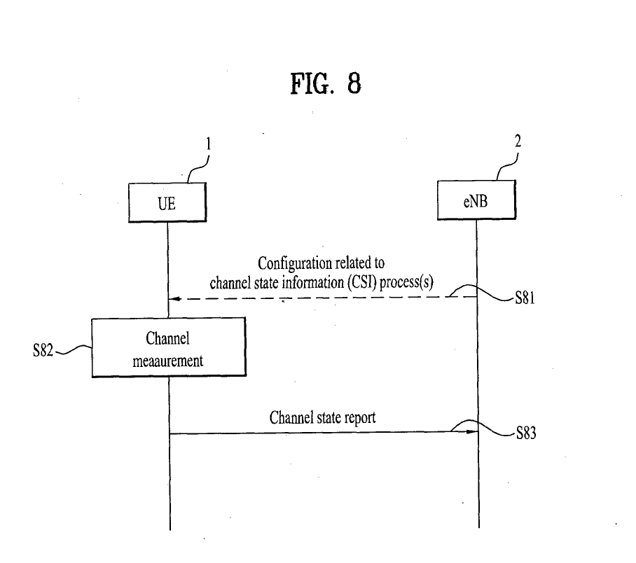

FIG. 8 illustrates an operation according to an embodiment of the present invention. The operation may be performed in a wireless communication system in which each of N eNBs (N is 2 or a larger integer) transmits one or more independent layers to a UE. That is, the wireless communication system may adopt the afore-described ILJT scheme. A UE 1 may receive configuration information related to a CSI process from a serving eNB 2 (S81). The configuration information may include information about CSI-RS resource i (i=0, . . . , N−1) and one CSI-IM resource. CSI-RS resource i may be allocated to an i^{th} eNB from among the N eNBs.

The UE 1 may perform channel measurement on each of the N eNBs (S82). That is, the UE may perform channel measurement in CSI-RS resource i to measure a downlink channel Hᵢ from eNB i.

In general, the UE 1 calculates a PMI and an RI that maximize the throughput of a downlink channel in the configured CSI-RS resource and a CQI corresponding to the PMI and the RI and reports the PMI, the RI, and the CQI to the serving eNB 2.

The UE 1 may transmit a channel state report to the serving eNB 2 as a result of the channel measurement (S83). That is, the UE 1 may calculate PMIᵢ and RIᵢ that maximize the throughput of downlink channels from the N eNBs and CQIᵢ achieved from PMIᵢ and RIᵢ and transmit the calculated values to the serving eNB 2. Meanwhile, since each eNB participating in the communication transmits an independent layer to the UE 1, interference may occur between transmission layers of eNBs in the wireless communication system. Accordingly, if downlink transmission from a specific eNB reduces the throughput of a downlink channel, the UE 1 may determine RIᵢ for the eNB to be 0 and report the RI. In this case, the UE 1 may exclude PMIᵢ and/or CQIᵢ from the channel state report.

Therefore, RIᵢ may range from 0 to Lₘₐₓ where Lₘₐₓ may be the maximum number of layers receivable at the UE.

The embodiment of the present invention illustrated in FIG. 8 may include at least a part of the afore-described embodiment(s) alternatively or additionally.

While it has been described in the embodiment of the present invention illustrated in FIG. 8 that configuration information about a CSI process is received from a serving eNB from among N eNBs and a CSI report based on the configuration information is transmitted to the serving eNB, it will be apparent to those skilled in the art that configuration information about a CSI process may be received from at least one eNB and a CSI report based on the configuration information may be transmitted to the at least one eNB.

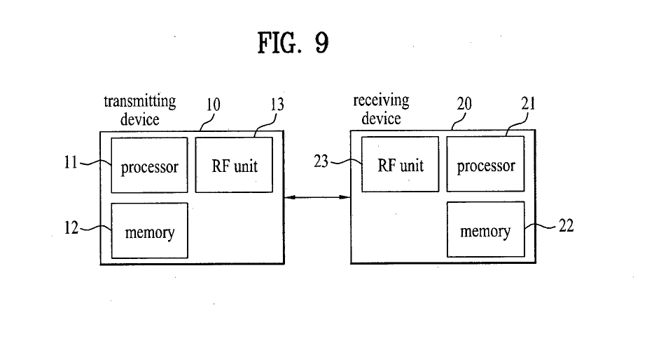

FIG. 9 is a block diagram of a transmitting device 10 and a receiving device 20 configured to implement exemplary embodiments of the present invention. Referring to FIG. 9, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

The transmitting device and/or the receiving device may be configured as a combination of one or more embodiments of the present invention.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

### MODE FOR INVENTION

Various embodiments have been described in the best mode for carrying out the invention.

### INDUSTRIAL APPLICABILITY

The present invention is applicable to a wireless communication device such as a UE, a relay, an eNB, etc.

It will be apparent to those skilled in the art that various modifications and variations can be made in the present invention without departing from the spirit or scope of the invention. Thus, it is intended that the present invention cover the modifications' and variations of this invention provided they come within the scope of the appended claims and their equivalents.

1. A method for reporting a downlink channel state to a serving Base Station (BS) at a User Equipment (UE) in a wireless communication system in which each of N (N is an integer equal to or larger than 2) BSs transmits one or more independent layers to the UE, the method comprising:
receiving configuration information about a channel state information reference signal (CSI-RS) process including CSI-RS resource i (i=0, . . . , N−1) and one channel state information interference measurement (CSI-IM) resource, the CSI-RS resource i being allocated to a BS i from among the N BSs;
performing channel measurement in the CSI-RS resource i to measure downlink channel Hᵢ from the BS i; and
transmitting, to the serving BS, a channel state report including a precoding matrix index i (PMIᵢ) and a rank indicator i (RIᵢ), which maximize throughput of downlink channels from the N BSs, and/or a channel quality indicator i (CQIᵢ),
wherein the RIᵢ ranges from 0 to Lₘₐₓ and Lₘₐₓ is a maximum number of layers which the UE is able to receive.

2. The method according to claim 1, wherein the sum of N RI(RIᵢ)s is equal to or smaller than Lₘₐₓ.

3. The method according to claim 1, wherein if the RIᵢ is 0, the PMIᵢ and the CQIᵢ are excluded from the channel state report.

4. The method according to claim 1, wherein if the sum RI_{c} of N RI(RIᵢ)s is larger than 1, a CQI for codeword 0, CQIᵢ_{_{—}}₀ and a CQI for codeword 1, CQIᵢ_{_{—}}₁ are included in the channel state report, and
wherein RI_{c} layers are indexed in an ascending order, starting from a layer transmitted from a low-index BS, the codeword 0 is mapped to layers having low indexes, and the codeword 1 is mapped to layers having high indexes.

5. The method according to claim 4, wherein if the RI_{c} is an even number, the number of layers to which the codeword 0 is mapped is the same as the number of layers to which the codeword 1 is mapped, and
wherein if the RI_{c} is an odd number, the number of layers to which the codeword 1 is mapped is larger than the number of layers to which the codeword 0 is mapped by 1.

6. The method according to claim 1, wherein if the sum RI_{c} of N RI(RIᵢ)s is larger than 1, a CQI for codeword 0, CQIᵢ_{_{—}}₀ and a CQI for codeword 1, CQIᵢ_{_{—}}₁ are included in the channel state report, and
wherein RIᵢ layers of each BS are indexed sequentially in an ascending order, the codeword 0 is mapped to layers having low indexes transmitted from each BS, and the codeword 1 is mapped to layers having high indexes transmitted from each BS.

7. The method according to claim 6, wherein if the RIᵢ is an even number, the number of layers to which the codeword 0 is mapped is the same as the number of layers to which the codeword 1 is mapped, and
wherein if the RIᵢ is an odd number, a new index is assigned to a BS having the odd number RIᵢ,
if the new index is an even number, the number of layers to which the codeword 1 is mapped is larger than the number of layers to which the codeword 0 is mapped by 1, and
if the new index is an odd number, the number of layers to which the codeword 0 is mapped is larger than the number of layers to which the codeword 1 is mapped by 1.

8. The method according to claim 1, further comprising reflecting interference from one or more layers received from a BS for which the RIᵢ is not 0 in calculating the CQIᵢ.

9. The method according to claim 8, further receiving information indicating that each of the N BSs transmits one or more independent layers to the UE.

10. A User Equipment (UE) for reporting a downlink channel state to a serving Base Station (BS) in a wireless communication system in which each of N (N is an integer equal to or larger than 2) BSs transmits one or more independent layers to the UE, the UE comprising:
a Radio Frequency (RF) unit; and
a processor configured to control the RF unit,
wherein the processor is configured to receive configuration information about a channel state information reference signal (CSI-RS) process including CSI-RS resource i (i=0, . . . , N−1) and one channel state information interference measurement (CSI-IM) resource, the CSI-RS resource i being allocated to BS i from among the N BSs, perform channel measurement in CSI-RS resource i to measure downlink channel Hᵢ from BS i, and transmit, to the serving BS, a channel state report including a precoding matrix index i (PMIᵢ) and a rank indicator i (RIᵢ), which maximize throughput of downlink channels from the N BSs, and/or a channel quality indicator i (CQIᵢ), and
wherein the RIᵢ ranges from 0 to Lₘₐₓ and Lₘₐₓ is a maximum number of layers which the UE is able to receive.
